(19) United States
(12) Patent Application Publication
(10) Pub. No.: US 2013/0088616 A1
(43) Pub. Date: Apr. 11, 2013

(54) Image Metadata Control Based on Privacy Rules

(71) Applicant: Michael I. Ingrassia, JR., Cupertino, CA (US)

(72) Inventor: Michael I. Ingrassia, JR., Cupertino, CA (US)

(73) Assignee: APPLE INC., Cupertino, CA (US)

(21) Appl. No.: 13/270,159

(22) Filed: Oct. 10, 2011

(51) Int. Cl. H04N 5/76

(52) U.S. Cl. 348/231.5; 348/231.3; 348/E05.024

(57) ABSTRACT

Systems, methods, and computer readable media for managing image metadata based on the use of rules are described. In general, this disclosure describes how to control the recordation of image metadata through the use of rules. More particularly, rules may be specified that are “executed” against an image's metadata at capture time. Depending upon whether the rule was satisfied and what the rule's specified action is, image metadata may be retained, removed or modified as the image and its metadata is stored.

### BACKGROUND

This disclosure relates generally to the field of data management. More particularly, this disclosure relates to a technique for managing image metadata based on the use of rules.

Most digital image capture devices record, in addition to images, data associated with those images. Known as metadata, this information may include virtually any type of information associated with the image. Illustrative types of image metadata include date and time-stamp information and camera settings such as exposure time, f-number and compression. In many newer devices image metadata may also include location information (e.g., GPS data). In addition, many modern digital image capture devices include the ability to process image data—the results of which may create additional metadata. Metadata of this latter type could, for example, include identification of the city and state of where an image was taken or, using facial recognition techniques, the identify of individuals in an image.

It has recently become possible to capture an image (or video stream) and, within minutes, have it posted to a public web site. Once so posted, anyone in the world having access to the World Wide Web (via the Internet) can view, download and manipulate the image—including the image's metadata. At present, users have only a very limited ability to restrict the metadata that is captured with an image and, therefore, only a very limited ability to restrict the capture and/or dissemination of that information. This situation can create significant privacy issues, for both the person taking the image as well as those in the image. Thus, it would be beneficial to provide a mechanism to control the capture of image metadata.

### SUMMARY

In one embodiment a rules-based metadata privacy method for digital images is described. The method includes obtaining an image (from an image sensor) and image metadata. Image metadata may include, but is not limited to, image capture parameters (e.g., shutter speed), image capture device identification (e.g., make and model of the device), location information (e.g., GPS data) and identified individuals (e.g., through facial recognition techniques). A metadata processing rule may be obtained (from, for example, a memory or database) and applied or evaluated against at least some of the image's metadata to identify an action. The action may be used to update the image's metadata and, thereafter, the image and the updated metadata may be stored to a long-term memory (e.g., a solid-state memory disk). Actions include removing some or all of the image's metadata, modifying some or all of the image's metadata, or doing nothing (i.e., not changing) to the image's metadata. In another embodiment, the method may be at least partially implemented by computer code stored in a non-transitory computer readable medium. In accordance with still other embodiments, a device may be used to implement the described methods. Illustrative devices include mobile telephones, personal digital assistants, personal music/video players and notebook and tablet computers.

### BRIEF DESCRIPTION OF THE DRAWINGS

FIG. 1 shows a conceptual image processing pipeline in accordance with one embodiment.

FIG. 2 shows, in flowchart form, an image metadata control method based on privacy rules in accordance with one embodiment.

FIG. 3 shows, in block diagram form, an illustrative multifunction electronic device that may be used to implement one or more operations in accordance with this disclosure.

FIG. 4 shows, in flowchart form, an image metadata control method based on privacy rules in accordance with another embodiment.

### DETAILED DESCRIPTION

This disclosure pertains to systems, methods, and computer readable media for managing image metadata. In general, this disclosure describes how to control the recordation of image metadata through the use of rules. More particularly, rules may be specified that are “executed” against an image's metadata at capture time. Depending upon whether the rule was satisfied (aka, triggered) and what the rule's specified action is, image metadata may be retained, removed or modified as the image and its metadata is stored to a long-term storage medium.

In the following description, for purposes of explanation, numerous specific details are set forth in order to provide a thorough understanding of the inventive concept. As part of this description, some of this disclosure's drawings represent structures and devices in block diagram form in order to avoid obscuring the invention. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the invention, and multiple references to “one embodiment” or “an embodiment” should not be understood as necessarily all referring to the same embodiment.

It will be appreciated that in the development of any actual implementation (as in any development project), numerous decisions must be made to achieve the developers' specific goals (e.g., compliance with system- and business-related constraints), and that these goals will vary from one implementation to another. It will also be appreciated that such development efforts might be complex and time-consuming, but would nevertheless be a routine undertaking for those of ordinary skill in the design of image capture devices having the benefit of this disclosure.

Modern digital image capture devices include stand-alone cameras as well other devices in which image capture capabilities have been embedded such as mobile telephones, personal digital assistants, personal music and video players and notebook and tablet portable computers. For convenience, the term “camera” will be used herein to refer to any device capable of capturing digital images. Just as there are many types of cameras, there are many file formats the maker of a camera may use (e.g., TIFF, PNG, GIF, JPEG and RAW). In addition, there are many different formats in which metadata may be recorded (e.g., Exif, IPTC, Dublin Core, PLUS and XMP). For illustrative purposes, therefore, a camera generating JPEG files and Exif metadata will be assumed throughout the remainder of this disclosure. It is to be understood, however, that this selection is not meant to be limiting. The principles and techniques described herein are applicable to any file format using any metadata structure. Along these same lines, it should be recognized that many image file formats can include metadata stored in accordance with different standards, with some of these file formats able to contain metadata stored in accordance with different standards at the same time. It should be further understood that a single metadata datum may be stored in different metadata elements or containers within an image file.

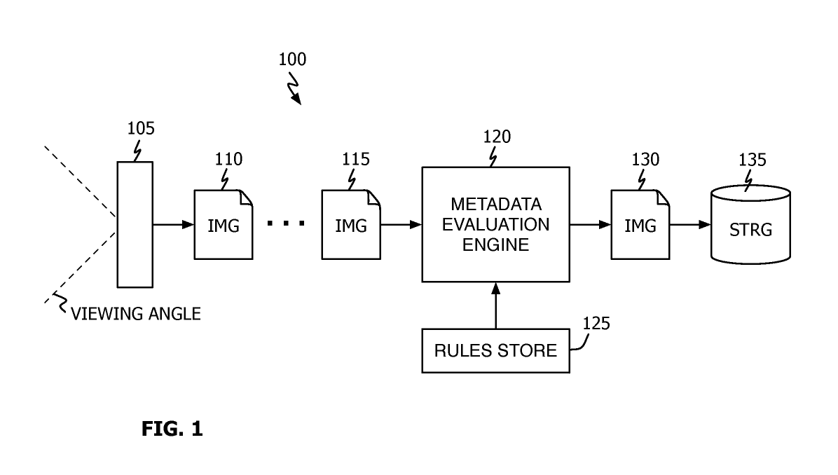

Referring to FIG. 1, image processing pipeline 100 in accordance with one embodiment is shown. Lens/sensor assembly 105 captures image 110 which may then has its metadata updated as it is “processed.” By way of example, image 110 may include time-date, GPS and camera metadata. A second version of the image (not shown) may include location information such as identification of the city and state in which the image was captured. A third version of the image (not shown) may include face and/or object identification. Image 115 may include facial recognition information such as the identity of one or more people and/or one or more specified objects (e.g., a plane, a car) in the image. Once image metadata has been captured/processed and associated with the image, metadata evaluation engine 120 may apply one or more rules from rules store 125 to the image's metadata. Rules store 125 could, for example, be a simple list, a structured file or a database. As a result of applying one or more rules, metadata evaluation engine 120 may remove, retain or modify the image's metadata to generate final version of the image, image 130, which may then be placed into long-term storage 135 (e.g., a solid-state disk or other “permanent” memory).

It will be recognized that image processing pipeline 100 is conceptual in nature. Specifically, images 110, 115 and 120 while shown as separate entities may be a single entity—where each entity represents a version of a single image and its metadata. In practice, lens/sensor assembly 105 may capture an image to a local short-term memory which can include metadata storage. It is this memory that may be updated in accordance with the above discussion with respect to images 110 to 115. Metadata evaluation engine 120 may interrogate that same memory when applying rules and when removing, retaining or modifying the image's metadata to generate image 130. Thus, a user's privacy preferences (embodied in the rules retained in rules store 125) may be applied before an image is ever committed to long-term memory (e.g., non-transitory storage 135). (It will be recognized that, once an image is in long-term storage it may more easily be copied, including its metadata.)

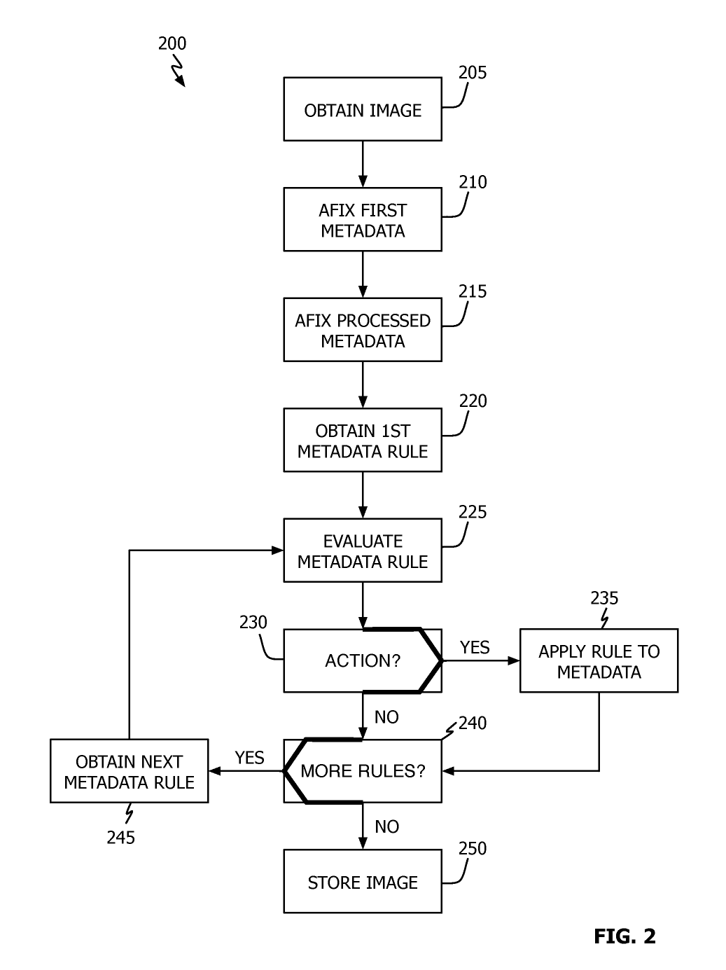

Referring to FIG. 2, rules-based metadata privacy operation 200 in accordance with one embodiment begins once an image is captured by, for example, lens/sensor assembly 105 and before the image is committed to long-term storage 135 (block 205). A first collection of metadata may be affixed to or associated with the captured image such as time-date, camera setting and GPS information (block 210). Additional metadata may then be attached to or incorporated into the image's metadata as a result of processing (block 215). For example, face recognition algorithms may be applied to the image to identify one or more people. Once all of the image's relevant metadata has been obtained and associated with the image, a first metadata rule may be obtained (block 220) and evaluated against the image's metadata (block 225). If the rule's conditions are satisfied (the “YES” prong of block 230), the rule's actions are performed (block 235). If the rule's conditions are not satisfied (the “NO” prong of block 230) or following acts in accordance with block 235, a check may be made to determine if additional rules remain to be evaluated (block 240). If at least one rule remains to be evaluated (the “YES” prong of block 240), the next rule is obtained (block 245) whereafter operation 200 continues at block 225. If, on the other hand, no more rules remain to be evaluated (the “NO” prong of block 240), the image (and its metadata as removed, retained or modified by one or more rules) may be placed into long-term storage (block 250).

As can be seen from the above discussion, metadata evaluation engine 120 serves the function of a rule interpreter. In one embodiment, rules store 125 may include any number of rules. Although not necessary, as used herein a rule may be thought of as having the following structure: IF <condition> THEN <action>. Where “condition” is a logical combination of possible metadata values and “action” is what to do if the “condition” is true. Table 1 shows, by way of example, a few possible rules that may be used in accordance with this disclosure.

TABLE 1
Example Privacy Rules

| <condition> | <action> |
|---|---|
| privacy | remove location and identity metadata |
| privacy and location within | remove location and identity metadata |
| region-A | |
| privacy and location not within | do nothing |
| region-A | |
| privacy | remove designated privacy metadata |
| privacy | modify GPS location metadata with city |
| | and state designation |
| privacy | remove camera identification metadata |

As used in Table 1, the value “privacy” indicates a user has selected a privacy mode in which identifying image metadata may be altered (e.g., modified or removed). This could be an option made available through a user interface. For example, if the user wants to record all of an image's metadata (or does not care if this is done), they could set a “privacy” preference to OFF. The first rule shown in Table 1 indicates that if the camera's privacy option has been selected (privacy=TRUE), then all of an image's location metadata (e.g., GPS value as well as any processed location metadata such as city and state) and all personal identification metadata (e.g., user name and facial identification metadata) would be removed from the image prior to placing the image into long-term storage. The second rule shown in Table 1 indicates that if the camera's privacy option has been selected and the image's location metadata indicates a position within a defined region-A (e.g., using geo-fencing techniques), then all of an image's location metadata and all personal identification metadata would be removed from the image prior to placing the image into long-term storage. The third rule shown in Table 1 is very similar, except now if the image's location metadata indicates a position within a defined region-A, no metadata will be changed.

The fourth rule shown in Table 1 illustrates another operation possibility. Here, it is assumed a user can designate selected types of metadata as “privacy” metadata. For example, a user interface may present to a list of all possible metadata (or a subset selected by the camera's manufacturer), and the user could select which of these they wish to designate as “privacy” metadata. In accordance with the fourth rule of Table 1, if the camera's privacy option has been selected, then all of the metadata designated by the user as “privacy” metadata would be removed from the image prior to placing the image into long-term storage. Similarly, a user may select different combinations of metadata under different designated labels, using these labels in privacy rules. For example, a first set of privacy metadata could be metadata that identifies the camera. A second set of privacy metadata could be metadata that identifies the image's location. And, a third set of privacy metadata could be metadata that identifies individuals in an image.

When rule store 125 includes more than one rule, conflicts between rules may arise. For example, if there are two rules as shown in Table 2, then the truth of a single condition (privacy=TRUE), would suggest two actions, both of which cannot be satisfied. This issue may be addressed in several ways. In a first illustrative approach to this issue, each rule could be assigned a priority so that from all of the rules whose conditions has been met, only the action of the highest priority rule would be performed. If two rules have the same priority, a “tie-breaking” determination cold be used (e.g., first rule evaluated).

TABLE 2
Example Conflicting Rules

Rule 1: IF privacy THEN remove location metadata
Rule-2: IF privacy THEN do not remove location metadata

In a second illustrative approach to this issue, the first rule evaluated whose condition is true could be selected (i.e., its action performed). In still another embodiment, the rules could be arranged into a hierarchy (e.g., through a graphical user interface). Here, the rule's location within the hierarchy could denote its priority. In yet another embodiment, if conflicting rules are selected, metadata evaluation engine 120 could choose that rule whose privacy action is most severe—this would be a conservative approach. Of course, the opposite could also be selected so that the least restrictive action, vis-à-vis an image's metadata, would be selected.

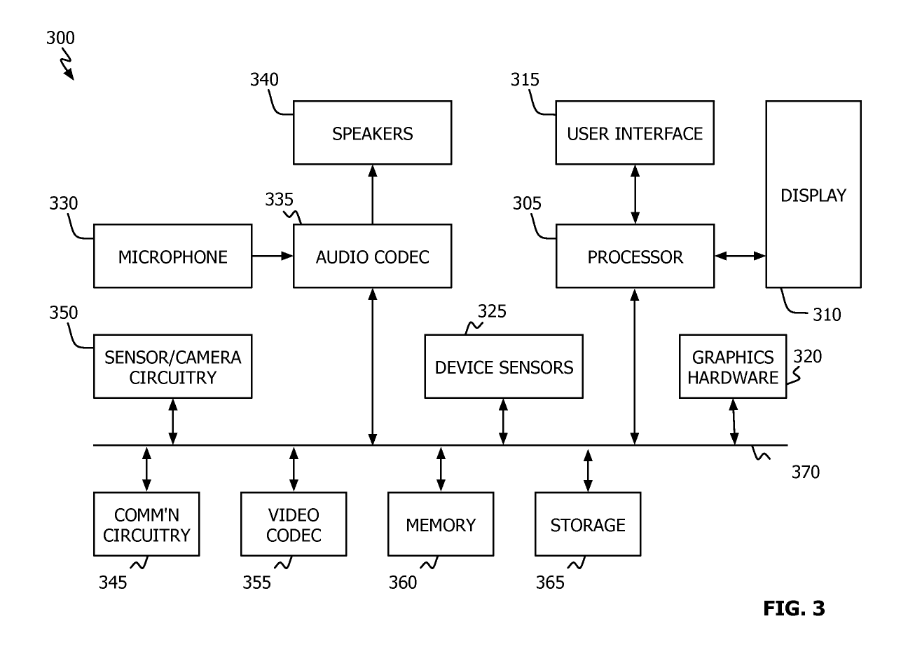

Referring now to FIG. 3, a simplified functional block diagram of illustrative multifunction device 300 is shown according to one embodiment. Multifunction device 300 may include processor 305, display 310, user interface 315, graphics hardware 320, device sensors 325 (e.g., proximity sensor/ambient light sensor, accelerometer and/or gyroscope), microphone 330, one or more audio codecs 335, one or more speakers 340, communications circuitry 345, digital image capture unit 350 (e.g., providing, at least in part, the functionality described in FIG. 2) one or more video codecs 355, memory 360, storage device 365, and communications bus 370. Multifunction device 300 may be, for example, a digital camera or a personal electronic device such as a personal digital assistant (PDA), personal music/video player, mobile telephone, or a tablet computer.

Processor 305 may execute instructions necessary to carry out or control the operation of many functions performed by device 300 (e.g., such as the generation and/or processing of images in accordance with FIGS. 1 and 2). Processor 305 may, for instance, drive display 310 and receive user input from user interface 315. User interface 315 may allow a user to interact with device 300. For example, user interface 315 can take a variety of forms, such as a button, keypad, dial, a click wheel, keyboard, display screen and/or a touch screen. Processor 305 may also, for example, be a system-on-chip such as those found in mobile devices and include a dedicated graphics processing unit (GPU). Processor 305 may be based on reduced instruction-set computer (RISC) or complex instruction-set computer (CISC) architectures or any other suitable architecture and may include one or more processing cores. Graphics hardware 320 may be special purpose computational hardware for processing graphics and/or assisting processor 305 to process graphics information. In one embodiment, graphics hardware 320 may include a programmable graphics processing unit (GPU).

Sensor and camera circuitry 350 may capture still and video images that may be processed, at least in part, by video codecs 355 and/or processor 305 and/or graphics hardware 320, and/or a dedicated image processing unit incorporated within circuitry 350. Images so captured may be stored in memory 360 and/or storage 365 (e.g., long-term and non-transitory storage 135). Memory 360 may include one or more different types of media used by processor 305 and graphics hardware 320 to perform device functions. For example, memory 360 may include memory internal to circuitry 350, memory cache, read-only memory (ROM), and/or random access memory (RAM). Storage 365 may store media (e.g., audio, image and video files), computer program instructions or software, preference information, device profile information, and any other suitable data. Storage 365 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 360 and storage 365 may be used to tangibly retain computer program instructions or code organized into one or more modules and written in any desired computer programming language. When executed by, for example, processor 305 such computer program code may implement one or more of the methods described herein.

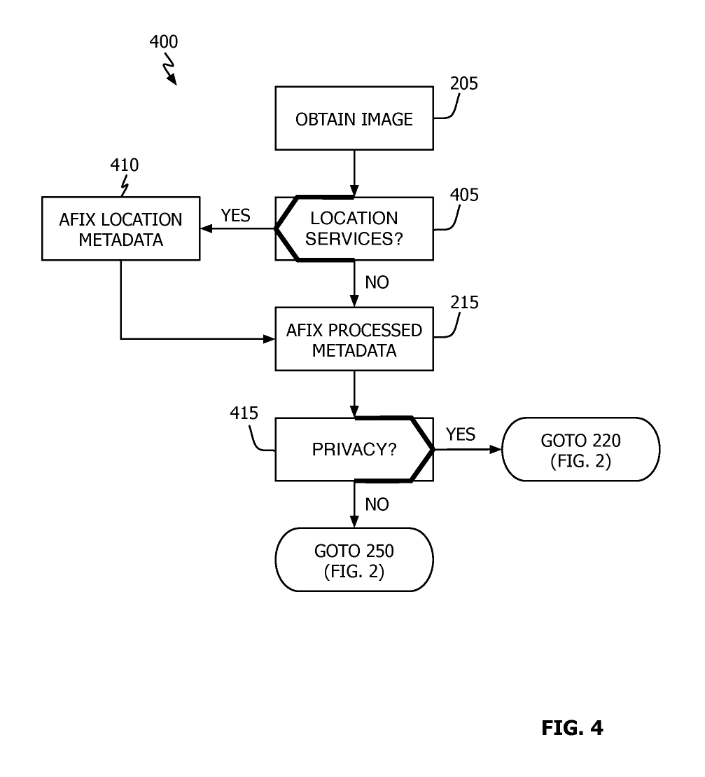

Various changes in the materials, components, circuit elements, as well as in the details of the illustrated operational methods are possible without departing from the scope of the following claims. For instance, some camera's provide the user with an option to record, or not record, location metadata during image capture operations (e.g., GPS data). The rules-based privacy operations described herein could be used in conjunction with such devices as illustrated in FIG. 4. As in FIG. 2, rules-based privacy operation 400 begins once an image is obtained (block 205) but before it is placed into long-term storage. A check can then be made to determine if the user has specified that location metadata should be recorded (block 405). If location metadata is to be recorded (the “YES” prong of block 405), location metadata may be affixed to or associated with the image (block 410), whereafter operation 400 continues at block 215 (se discussion above with respect to FIG. 2). If location metadata is not to be recorded (the “NO” prong of block 405), then no such metadata is affixed to or associated with the image, whereafter processed metadata in accordance with block 215 may be affixed to or associated with the image. If a rules-based privacy mode is active (the “YES” prong of block 415), operations continue at block 220 of FIG. 2. If, on the other hand, a rules-based privacy mode is not active (the “NO” prong of block 415), the image may be placed into long-term storage in accordance with block 250 of FIG. 2.

Finally, it is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A rules-based metadata privacy method, comprising:
obtaining an image from an image sensor;
obtaining metadata for the image, the metadata describing one or more aspects of the image;
evaluating the metadata in accordance with a metadata processing rule to identify an action, wherein the act of evaluating occurs before the image is stored in a long-term storage medium;
preforming the action on the metadata to generate modified metadata, wherein the act of performing occurs before the image is stored in the long-term storage medium; and
storing the image and the modified metadata in the long-term storage medium.

2. The method of claim 1, wherein the metadata comprises one or more of location metadata, face detection metadata, face recognition metadata, image capture device metadata, and time metadata.

3. The method of claim 1, wherein the act of evaluating comprises obtaining the metadata processing rule from a data store.

4. The method of claim 1, wherein the action comprises storing some, but not all, of the metadata with the image in the long-term storage medium.

5. The method of claim 1, wherein the action comprises removing all of the metadata from the image.

6. The method of claim 1, wherein the act of evaluating the metadata comprises evaluating face recognition metadata.

7. The method of claim 6, wherein the action comprises storing the metadata without the face recognition metadata with the image in the long-term storage medium.

8. The method of claim 7, wherein the action further comprises storing the metadata without location metadata with the image in the long-term storage medium.

9. The method of claim 1, wherein the act of evaluating the metadata comprises evaluating location information.

10. The method of claim 9, wherein the act of evaluating location information comprises determining the image was obtained within a specified geographic region.

11. The method of claim 10, wherein the act of evaluating location information comprises further comprises identifying a city in which the image was obtained.

12. The method of claim 11, wherein the action comprises storing an indicator of the identified city in the metadata.

13. The method of claim 1, wherein the action comprises storing the metadata without camera identification metadata with the image in the long-term storage medium.

14. The method of claim 1, wherein the act of evaluating comprises identifying at least a portion of the metadata as private metadata.

15. The method of claim 14, wherein the action comprises storing the metadata without the metadata identified as private metadata with the image in the long-term storage medium.

16. A non-transitory computer readable medium, comprising:
computer code to obtain an image from an image sensor;
computer code to obtain metadata for the image, the metadata describing one or more aspects of the image;
computer code to evaluate the metadata in accordance with a metadata processing rule to identify an action, wherein the computer code to evaluate is executed before the image is stored in a long-term storage medium;
computer code to preform the action on the metadata to generate modified metadata; and
computer code to store the image and the modified metadata in the long-term storage medium.

17. A digital image capture device, comprising:
an image sensor;
image sensor memory, operatively coupled to the image sensor;
a location sensor operatively coupled to the image sensor memory;
long-term storage operatively coupled to the image sensor memory;
a memory having computer program code stored therein; and
a processor operatively coupled to the image sensor memory, the memory and the long-term storage, the processor adapted to execute computer code to—
determine the image sensor has placed an image in the image sensor memory,
obtain a metadata processing rule,
evaluate the metadata processing rule against metadata associated with the image to identify an action,
perform the action on the metadata to generate modified metadata, and
cause the image and the modified metadata to be transferred to the long-term storage.
